(19) United States
(12) Patent Application Publication
(10) Pub. No.: US 2017/0255750 A1
(43) Pub. Date: Sep. 7, 2017

(54) SYSTEM AND METHOD FOR RECOMMENDING A DISCHARGE MOMENT

(71) Applicant: KONINKLIJKE PHILIPS N.V., Eindhoven (NL)

(72) Inventors: Gijs GELEIJNSE, Geldrop (NL); Ana Jorge RODRIGUES DE MOURA LEITAO, Eindhoven (NL)

(21) Appl. No.: 15/437,029

(22) Filed: Feb. 20, 2017

Related U.S. Application Data
(60) Provisional application No. 62/303,885, filed on Mar. 4, 2016.

(51) Int. Cl. G06F 19/00

(52) U.S. Cl. CPC G06F 19/322

(57) ABSTRACT

The present disclosure pertains to a system configured to recommend a discharge moment for a subject. The system obtains electronic medical information associated with the subject; determines a current clinical status of the subject; predicts a clinical status for the subject at one or more individual moments in the future; predicts care needs for the subject at the one or more individual moments in the future; obtains information indicating medical services and programs offered and available to the subject at the one or more individual moments in the future and whether the offered available medical services and programs meet the subject's predicted needs at the one or more individual moments; predicts costs and likely clinical outcomes for the subject for discharge at the one or more individual moments in the future; and recommends one of the individual moments in the future as the discharge moment.

### CROSS-REFERENCE TO PRIOR APPLICATIONS

This application claims the benefit of or priority of U.S. patent application Ser. No. 62/303,885, filed Mar. 4, 2016, which is incorporated herein in whole by reference.

### BACKGROUND OF THE INVENTION

The present disclosure pertains to a system and method for recommending a discharge moment for a subject.

Typically, health plan administrators track the healthcare costs of their beneficiaries and attempt to provide appropriate services to reduce these costs. For example, health plan administrators analyze their own claims and authorization databases and invite beneficiaries to participate in chronic disease management programs (e.g., telecare) and preventive medicine programs (e.g., cooking classes for diabetes patients) to promote health and reduce (future) health care costs.

### SUMMARY OF THE INVENTION

Accordingly, one or more aspects of the present disclosure relate to a system configured to recommend a discharge moment for a subject. The system comprises one or more hardware processors and/or other components. The one or more hardware processors are configured by machine-readable instructions to: obtain electronic medical information associated with the subject, the electronic medical information indicating a clinical progression of the subject, a medical billing history associated with the subject, and a medical procedure authorization history associated with the subject; determine a current clinical status of the subject based on the clinical progression; predict a clinical status for the subject at one or more individual moments in the future based on the current clinical status, the clinical progression, the medical billing history, and the medical procedure authorization history; predict care needs for the subject at the one or more individual moments in the future based on the predicted clinical status; obtain information indicating medical services and programs offered and available to the subject at the one or more individual moments in the future and whether the offered available medical services and programs meet the subject's predicted needs at the one or more individual moments; predict costs and likely clinical outcomes for the subject for discharge at the one or more individual moments in the future based on the predicted clinical status and when the medical services and programs that meet the predicted needs of the subject and are offered and available; and recommend one of the one or more individual moments in the future as the discharge moment based on the obtained electronic medical information, the current clinical status, the predicted clinical status, the predicted care needs, the information indicating medical services and/or programs offered and available, the predicted costs and likely clinical outcomes, and/or other information.

Another aspect of the present disclosure relates to a method for recommending a discharge moment for a subject with a recommendation system. The system comprises one or more hardware processors and/or other components. The method comprises obtaining, with the one or more hardware processors, electronic medical information associated with the subject, the electronic medical information indicating a clinical progression of the subject, a medical billing history associated with the subject, and a medical procedure authorization history associated with the subject; determining, with the one or more hardware processors, a current clinical status of the subject based on the clinical progression; predicting, with the one or more hardware processors, a clinical status for the subject at one or more individual moments in the future based on the current clinical status, the clinical progression, the medical billing history, and the medical procedure authorization history; predicting, with the one or more hardware processors, care needs for the subject at the one or more individual moments in the future based on the predicted clinical status; obtaining, with the one or more hardware processors, information indicating medical services and programs offered and available to the subject at the one or more individual moments in the future and whether the offered available medical services and programs meet the subject's predicted needs at the one or more individual moments; predicting, with the one or more hardware processors, costs and likely clinical outcomes for the subject for discharge at the one or more individual moments in the future based on the predicted clinical status and when the medical services and programs that meet the predicted needs of the subject and are offered and available; and recommending, with the one or more hardware processors, one of the one or more individual moments in the future as the discharge moment based on the obtained electronic medical information, the current clinical status, the predicted clinical status, the predicted care needs, the information indicating medical services and/or programs offered and available, the predicted costs and likely clinical outcomes, and/or other information.

Still another aspect of present disclosure relates to a system for recommending a discharge moment for a subject. The system comprises means for obtaining electronic medical information associated with the subject, the electronic medical information indicating a clinical progression of the subject, a medical billing history associated with the subject, and a medical procedure authorization history associated with the subject; means for determining a current clinical status of the subject based on the clinical progression; means for predicting a clinical status for the subject at one or more individual moments in the future based on the current clinical status, the clinical progression, the medical billing history, and the medical procedure authorization history; means for predicting care needs for the subject at the one or more individual moments in the future based on the predicted clinical status; means for obtaining information indicating medical services and programs offered and available to the subject at the one or more individual moments in the future and whether the offered available medical services and programs meet the subject's predicted needs at the one or more individual moments; means for predicting costs and likely clinical outcomes for the subject for discharge at the one or more individual moments in the future based on the predicted clinical status and when the medical services and programs that meet the predicted needs of the subject and are offered and available; and means for recommending one of the one or more individual moments in the future as the discharge moment based on the obtained electronic medical information, the current clinical status, the predicted clinical status, the predicted care needs, the information indicating medical services and/or programs offered and available, the predicted costs and likely clinical outcomes, and/or other information. These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a schematic illustration of a system configured to recommend a discharge moment for a subject.

FIG. 2 illustrates operations performed by the system.

FIG. 3 illustrates determining costs and projected clinical outcomes for subject discharge on a current day and three different days in the future.

FIG. 4 illustrates a method for recommending a discharge moment for a subject with a recommendation system.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

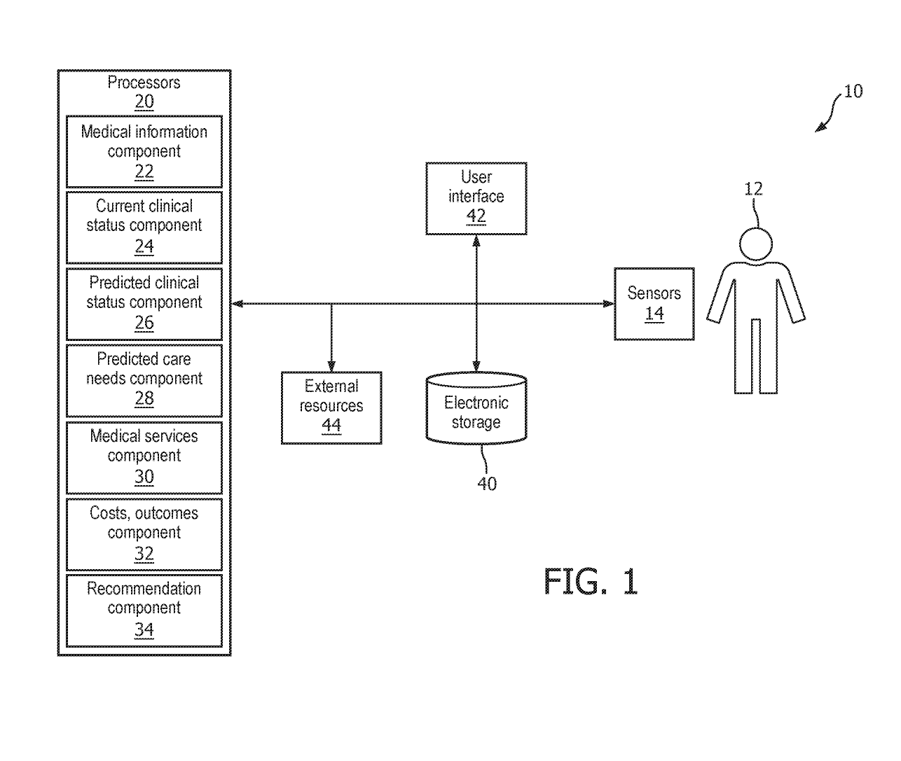

FIG. 1 is a schematic illustration of a system 10 configured to recommend a discharge moment for a subject 12. A discharge moment may include a particular day, a portion of a day (e.g., morning, afternoon, night, etc.), a time of day (e.g., 10:00 AM), a period of time (e.g., in the next 5 hours), and/or other discharge moments. System 10 may recommend a discharge moment for subject 12 from a hospital, a nursing home, from one unit of a hospital to another (e.g., from an intensive care unit to another area of the hospital), from an emergency room, from an urgent care provider, from a doctor's office, from an outpatient clinic, and/or from other medical service providing facilities. Health plan administrators often play a role in facilitating the discharge of patients (e.g., subject 12). In some embodiments, health plan administrators include doctors, nurses, clinical auditors, and/or other caregivers caring for patients in a medical facility (e.g., a hospital, a nursing home, an emergency room, an urgent care provider, a doctor's office, an outpatient clinic, etc.); insurance providers who provide health insurance for patients; administrators who manage medical facility operations; clinical auditors who visit patients at contracted hospitals; home care services managed by a health plan operator; and/or other health plan administrators. A common problem in healthcare in general is that discharge of patients (e.g., from hospitals) is unnecessarily delayed, often due to the complexity of coordinating care across locations and organizations. System 10 helps the health plan administrators decide to release patients at appropriate times (e.g., when appropriate post-discharge care is in place). Without appropriate post-discharge care in place, a patient might be forced to remain in a medical facility longer than necessary, leading to higher care costs and lower patient safety and satisfaction; or be released from the medical facility to an environment (e.g., home) where necessary post-discharge caregivers and/or required equipment is not present. System 10 is configured to recommend to health plan administrators an appropriate moment (e.g., date, time of day, etc.) of discharge to reduce care costs, while still ensuring patient safety. System 10 uses the clinical progression of patients as well as the historic billing and authorization data for patients and/or other information to determine a current and predicted clinical status of subject 12, and then predict future care needs of subject 12. These needs are compared with available services offered by the health plan, and for one or more possible discharge moments, system 10 determines projected costs and medical outcomes (e.g., healthy recovery, hospital readmission, etc.) for subject 12.

Typically, the discharge of a patient (e.g., subject 12) from a medical facility (e.g., a hospital, a nursing home, an emergency room, an urgent care provider, a doctor's office, an outpatient clinic, etc.) is often delayed by inefficiencies in terms of the arrangement of post-discharge services. These services are often only arranged at the time the patient is already ready for discharge. In addition, the post-discharge services and the professionals who manage them are not well integrated with the services and caregivers provided by the discharging medical facility (e.g., hospital). This results in patients staying longer in the medical facility than necessary. System 10 accelerates the arrangement of post-discharge services because system 10 predicts the care needs at multiple future moments in time. System 10 allows health plan administrators to better decide whether necessary care will be available at these future moments and plan for a variety of discharge services in advance of any actual discharge, thus reducing medical facility (e.g., hospital) bed days and costs. In some embodiments, system 10 comprises one or more of a sensor 14, a hardware processor 20, electronic storage 40, a user interface 42, external resources 44, and/or other components.

Sensors 14 are configured to generate output signals conveying information related to one or more vital signs and/or other physiological parameters of subject 12, and/or other information indicative of the clinical status of subject 12. In some embodiments, the output signals are received by processor 20, stored in electronic storage 40, received and stored by one or more servers included in external resources 44, and/or communicated to other devices. The vital signs and/or other physiological parameters of subject 12 include vital signs and/or physiological parameters including and/or related to weight of subject 12, blood pressure of subject 12, heart rate of subject 12, respiration rate of subject 12, blood chemistry of subject 12, hydration of subject 12, a respiration rate/output of subject 12, a blood oxygen level of subject 12, skin conductance and/or skin temperature of subject 12, body temperature of subject 12, the joint/muscular flexibility of subject 12, the blood circulation of subject 12, the cardiac output of subject 12, the relative health and/or sickness of subject 12, brain activity of subject 12, and/or other parameters. Sensors 14 may comprise one or more sensors that measure such parameters directly. For example, sensors 14 may be and/or include a heart rate sensor located on the chest of subject 12 or included in a smartphone associated with subject 12. Sensors 14 may comprise one or more sensors that generate output signals conveying information related to vital signs of subject 12 indirectly. For example, one or more sensors 14 may generate an output with vital signs information based on movement of subject 12 (e.g. movement detected via actigraphy signals from a bracelet on a wrist of subject 12 may indicate a higher heart rate). In some embodiments, sensors 14 may be and/or include one or more of a heart rate monitor, a blood pressure monitor, a weight scale, blood glucose meter, oxygen saturation measurement, and/or other sensors. In some embodiments, user interface 42 is configured to obtain physiological parameters, medical symptoms, and/or other information associated with subject 12 via a questionnaire presented to subject 12 on user interface 42 and/or via other methods. In such embodiments, the electronic medical information in the one or more external clinical databases is collected by one or more of the subject, by a caregiver in outpatient or inpatient settings, collected during previous visits to the hospital, or collected during a current hospital visit via the one or more physiological sensors and the user interface, for example.

Although sensors 14 are illustrated at a single location near subject 12, this is not intended to be limiting. Sensors 14 may include sensors disposed in a plurality of locations, such as for example, within and/or in communication with a smartphone associated with subject 12, coupled (in a removable manner) with clothing of subject 12, worn by subject 12 (e.g., as a headband, wristband, etc.), positioned to point at subject 12 (e.g., a camera that conveys output signals related to heart rate of subject 12), and/or in other locations. In some embodiments, sensors 14 are associated with a hospital and/or other care facility (e.g., a doctor's office), a caregiver (e.g., sensors 14 may be included in equipment used by a doctor, nurse, a caregiving family member, etc.), medical transportation services (e.g., sensors 14 may be included in an ambulance), subject 12 (e.g., sensors in a smartphone associated with subject 12), and/or include other sensors. Sensors 14 may generate output signals continuously, at predetermined intervals, responsive to presence of and/or interaction with subject 12, and/or at other times. In some embodiments, system 10 may not include sensors 14.

Processor 20 is configured to provide information processing capabilities in system 10. As such, processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., a server, computing devices associated with health plan administrators, computing devices associated with caregivers, computing devices associated with subject 12 and/or other users, sensors 14, user interface 42, devices that are part of external resources 44, and/or other devices.)

As shown in FIG. 1, processor 20 is configured via machine-readable instructions to execute one or more computer program components. The one or more computer program components may comprise one or more of a medical information component 22, a current clinical status component 24, a predicted clinical status component 26, a predicted care needs component 28, a medical services component 30, a costs and outcomes component 32, a recommendation component 34, and/or other components. Processor 20 may be configured to execute components 22, 24, 26, 28, 30, 32, and/or 34 by software; hardware; firmware; some combination of software, hardware, and/or firmware; and/or other mechanisms for configuring processing capabilities on processor 20.

It should be appreciated that although components 22, 24, 26, 28, 30, 32, and 34 are illustrated in FIG. 1 as being co-located within a single processing unit, in embodiments in which processor 20 comprises multiple processing units, one or more of components 22, 24, 26, 28, 30, 32, and/or 34 may be located remotely from the other components. The description of the functionality provided by the different components 22, 24, 26, 28, 30, 32, and/or 34 described below is for illustrative purposes, and is not intended to be limiting, as any of components 22, 24, 26, 28, 30, 32, and/or 34 may provide more or less functionality than is described. For example, one or more of components 22, 24, 26, 28, 30, 32, and/or 34 may be eliminated, and some or all of its functionality may be provided by other components 22, 24, 26, 28, 30, 32, and/or 34. As another example, processor 20 may be configured to execute one or more additional components that may perform some or all of the functionality attributed below to one of components 22, 24, 26, 28, 30, 32, and/or 34.

Medical information component 22 is configured to obtain electronic medical information associated with subject 12. The electronic medical information indicates a clinical progression of subject 12, a medical billing history associated with subject 12, a medical procedure authorization history associated with subject 12, household and/or other outpatient conditions that exist where subject 12 is to be transferred, preferences of subject 12, a discharge history of subject 12, and/or other information. In some embodiments, the electronic medical information is obtained from one or more external clinical databases that include the information indicating the clinical progression of subject 12 and/or other information. Information indicating the clinical progression of subject 12 may indicate whether subject 12 is getting healthier, sicker, or staying the same; changes in a disease contracted by subject 12; changes in a physical condition of subject 12 (e.g., a bone and/or wound that is healing); and/or changes in other medical conditions of subject 12. The one or more external clinical databases may be included in, for example, electronic storage 40, external resources 44, and/or in other locations. The information indicating the clinical progression of the subject comprises one or more of vital signs levels of the subject, test results from tests performed on the subject, diagnoses associated with the subject, information describing treatments performed on the subject, information describing exercises performed by the subject, medications given to the subject, previous hospital admission and discharge dates for previous hospital visits by the subject, dates of medical office visits, notes recorded by a care giver, and/or other information.

In some embodiments, the one or more external clinical databases include medical information related to treatment of subject 12 that is electronically accessible to the health plan administrators. This information may be collected via self-managed healthcare services (e.g. a walk-in clinic, health plan associated specialist doctors), data collected by auditors and/or caregivers during hospital stays in hospitals contracted with the health plan, and/or collected in other ways. In some embodiments, the electronic medical information in the one or more external clinical databases is collected by one or more of subject 12, by a caregiver in outpatient or inpatient settings, collected during previous visits to the hospital, collected during a current hospital visit, and/or collected at other times. In some embodiments, the electronic medical information in the one or more external clinical databases is collected via sensors 14, user interface 42 (e.g., via a questionnaire as described above) and or other devices. In some embodiments, electronic medical information is received directly by medical information component 22 from sensors 14 and/or other equipment.

In some embodiments, the electronic medical information is obtained from one or more external billing and authorization databases. The one or more external billing and authorization databases may be included in, for example, electronic storage 40, external resources 44, and/or in other locations. The one or more external billing and authorization databases include the medical billing and authorization history of subject 12. The medical billing and authorization history of subject 12 includes one or more of processed billing codes, insurance payment information, diagnostic codes, past and pending authorization requests, and/or other information. In some embodiments, the one or more external billing and authorization databases include any billing and/or authorization information related to medical treatment of the subject 12 that is accessible to the health plan administrators. This information may be collected via self-managed healthcare services (e.g. a walk-in clinic, health plan associated specialist doctors), data collected by auditors and/or caregivers during hospital stays in hospitals contracted with the health plan, and/or collected in other ways. In some embodiments, the one or more external billing and authorization databases include insurance information related to subject 12, information related to past procedures performed on subject 12, consultations given to subject 12, diagnostic codes received by the health plan administrators for procedures performed on subject 12, and/or other information. In some embodiments, the one or more external billing and authorization databases include information related to past and pending authorization requests and their corresponding decisions for subject 12.

In some embodiments, the electronic medical information is obtained from one or more databases that store information related to the household and/or other outpatient conditions that exist where subject 12 is to be transferred, preferences of subject 12, and/or other information. These databases may be included in, for example, electronic storage 40, external resources 44, and/or in other locations. These databases include information indicating household and/or other outpatient conditions outside the medical facility where subject 12 is to be moved. For example, such information may indicate that subject 12 lives in house with minimal support equipment and/or caregivers; subject 12 lives in nursing home; subject 12 has a legal guardian and/or a responsible next of kin for care support, subject 12 has hired a private nurse, and/or other information. In some implementations, these databases include information conveying preferences and/or other behaviors of subject 12. For example, the information stored in these databases may indicate that subject 12 has previously checked out against medical advice after previous visits to medical facilities.

Current clinical status component 24 is configured to determine a current clinical status of subject 12 based on the clinical progression and/or other information. In some embodiments, determining the current clinical status of subject 12 based on the clinical progression includes individually quantifying a disease profile (e.g., International Classification of Diseases (ICD)-10), a disease severity (e.g., Global Strategy for the Diagnosis, Management, and Prevention of Chronic Obstructive Pulmonary Disease—GOLD, and/or a New York Heart Association (NYHA) Functional Classification), a clinical stability, a daily living ability (e.g., an ability to wash, walk, dress, etc.), therapy administered to subject 12 (e.g., knee surgery, renal dialysis, administering in IV, etc.) and/or other factors. In some embodiments, current clinical status component 24 obtains the information used to determine the current clinical status from medical information component 22 and/or from other sources. In some embodiments, the factors are individually quantified on a scale of 0, which corresponds to a healthy subject 12, to 1, which corresponds to a bedridden subject 12 requiring professional care, based on the information in the one or more external clinical databases and/or other information. In some embodiments, current clinical status component 24 is configured to quantify the individual factors on the 0-1 scale based on information stored in a predetermined electronic look-up table. The predetermined look up table may be included in external resources 44, for example, and/or other sources of information. In the look-up table, combinations of clinical statuses are associated with care needs. For example, for a patient with NYHA class IV who is completely bedridden, a hospice service may be considered. A patient with good functional status after an MI is associated with a cardiac rehab program together with frequent support from a cardiologist and a general practitioner. A patient who received surgery for a hip fraction may be associated with a physiotherapy program.

Predicted clinical status component 26 is configured to predict a clinical status for subject 12 at one or more individual moments (e.g., days, times, etc.) in the future. Predicted clinical status component 26 is configured to predict the clinical status for subject 12 based on the current clinical status of subject 12, the clinical progression (e.g., changes in the medical condition) of subject 12, the medical billing history for subject 12, the medical procedure authorization history for subject 12, and/or other information. For example, in some embodiments, predicted clinical status component 26 is configured such that over a subsequent “n” days, the predicted clinical statuses are determined based on a past disease progression of subject 12, a therapeutic plan for subject 12, ordered authorization requests for diagnostic tests and/or procedures for subject 12, and/or other factors. In some embodiments, predicted clinical status component 26 is configured to quantify daily predictions for the individual factors described above for the current clinical status on the same 0-1 scale.

In some embodiments, predicted clinical status component 26 is configured to compare the current clinical status of subject 12, the therapeutic plans and/or treatment order requests for subject 12 (e.g., upcoming tests, surgeries, drug therapies, doctor's visits, etc.), and/or other information related to subject 12 to a historic database of patient information. The historic database of patient information includes information about historic patients and their disease progression (changing clinical statuses over time), a description of the patients' associated medical conditions, the patients' corresponding billing history, and/or other information. In such embodiments, predicted clinical status component 26 may predict the clinical statuses for subject 12 based on this comparison.

Predicted care needs component 28 is configured to predict care needs for subject 12 at the one or more individual moments in the future based on the predicted clinical status and/or other information. In some embodiments, predicted care needs component 28 is configured such that predicting care needs for subject 12 includes determining a level of dependence on professional care for subject 12 at the one or more individual moments in the future. In some embodiments, predicted care needs component 28 is configured to predict care needs for subject 12 based on the factors quantified on the 0-1 scale by predicted clinical status component 26. For example, if subject 12 scores 0.9 on an individual factor which indicates that subject 12 would be “bedridden” at that potential discharge moment, then predicted care needs component 28 determines that professional care would be needed at that moment to assist subject 12 in bathing and toileting, for example. As another example, if subject 12 scores a 1.0 on a factor related to administering an intravenous (IV) medication, then predicted care needs component 28 determines that professional care should be available at the moments when administrating medication via an IV drip is necessary. Predicted care needs component 28 is configured such that need profiles like these are determined for “n” forecasted moments (e.g., days, times, etc.).

Medical services component 30 is configured to obtain information indicating medical services and programs offered and available to subject 12 at the one or more individual moments in the future. Medical services component 30 is configured to determine whether offered medical services and programs meet the predicted needs of subject 12 at the one or more individual moments. Then, medical services component 30 is configured to determine whether the offered medical services are available at those moments. In some embodiments, the offered medical services and availability information may be obtained from a services database (e.g., included in external resources 44), the databases that describe the household and/or other outpatient conditions that exist where subject 12 is to be transferred and/or the preferences of subject 12 (described above), and/or other sources. A services database may include information describing out-patient clinical services offered by an individual health plan and/or other sources. These services may range from cooking classes to 24 hour at-home nursing support, for example. The services database may include equipment information related to breathing assistance devices, physical therapy devices, sensors and/or monitors, IV equipment, a hospital bed at home, medication dispensers, wheel chair and/or other mobility support devices, emergency communication devices (e.g., usually coupled with sensors and configured to trigger an alarm that is transmitted to a medical facility in case of a suspected emergency), and/or other equipment. The information in the services database includes information related to a description of services (e.g., what medical conditions the services are intended to treat), levels of intensity of care, availability of equipment, availability of staff, service availability schedules, and/or other information.

For moments where discharge is possible (e.g., suitable out-patient services and/or equipment is offered and available considering the household and/or other outpatient conditions (described above) that exist where subject 12 is to be moved), medical services component 30 matches the predicted out-patient care needs with available services described in the database. For example, medical services component 30 is configured to check a services database of a health plan operator for the “n” upcoming days regarding whether or not out-patient services are offered that serve the needs of subject 12 predicted by predicted care needs component 28. Returning to the scenarios used in the examples above, if subject 12 scores 0.9 on an individual factor which indicates that subject 12 would be “bedridden” on a potential discharge day, then predicted care needs component 28 determines that professional care would be needed on that day (and/or on additional future days) to assist subject 12 in bathing and toileting, and medical services component 30 determines whether a caregiver will be available for that particular discharge date to assist subject 12. If subject 12 scores a 1.0 on a factor related to administering an IV, then predicted care needs component 28 determines that professional care should be available at the moments when administrating medication via an IV drip is necessary, and medical services component determines whether equipment needed for an IV drip and a caregiver trained to administer an IV drip are available for that discharge date (and/or following days). For moments (e.g., days) where discharge is possible (e.g., suitable out-patient services and/or equipment is identified), medical services component 30 matches the predicted out-patient care needs with the availability of the services in the database.

In some embodiments, medical services component 30 determines that no services and/or equipment is available that meets the needs of subject 12. For example, predicted clinical status component 26 and predicted care needs component 28 may determine that subject 12 will still be in unstable condition in an intensive care unit at a particular possible discharge moment. In this example, medical services component 30 determines that no services and/or equipment is available that meets the needs of subject 12 and system 10 recommends (described below) that subject 12 remain in the intensive care unit in the medical facility (e.g., hospital) and not be discharged to a different area of the medical facility or to the home of subject 12.

Costs and outcomes component 32 is configured to predict costs and likely clinical outcomes for subject 12 for discharge at the one or more individual moments in the future. Costs and outcomes component 32 is configured to predict the costs and likely clinical outcomes based on the predicted clinical status and when the medical services and programs that meet the predicted needs of the subject and are offered and available, and/or other information.

In some embodiments, predicting costs and likely clinical outcomes for subject 12 for discharge at the one or more individual moments in the future is based on the information stored in the historic database of patient information (e.g., included in external resources 44). As described above, the historic database of patient information includes a description of the patients' associated medical conditions, the patients' corresponding billing history, and/or other information. Costs and outcomes component 32 is configured to compare the predicted clinical status of subject 12, and the offered and available medical services and programs that meet the predicted needs of subject 12, to the information in the historic database of patient information and predict the costs and likely clinical outcomes for subject 12 for discharge at the one or more individual moments in the future based on the comparison.

In some embodiments, costs and outcomes component 32 is configured such that predicting costs and likely clinical outcomes for subject 12 includes electronically modelling subject 12 based on the current and predicted clinical statuses of subject 12, the billing data associated with subject 12, and/or other information. Costs and outcomes component 32 is configured to electronically model the clinical status for subject 12 at the one or more future moments assuming the necessary outpatient services (determined as described above) have been arranged. Costs and outcomes component 32 determines the likely costs for subject 12 over the next “m” moments (e.g. 180 days, 365 days, etc.) by comparing a predicted clinical progression (e.g., determined by predicted clinical status component 26) of the electronic model of subject 12 to the information for the historic population. Costs and outcomes component 32 predicts costs and outcomes for subject 12 over the next “m” moments (e.g., days) based on information stored in the historic database of patient information indicating a prognosis of similar historic patients.

Recommendation component 34 is configured to recommend one of the one or more individual moments in the future as a discharge moment. Recommendation component 34 is configured to recommend a discharge moment based on the obtained electronic medical information, the current clinical status, the predicted clinical status, the predicted care needs, the information indicating medical services and/or programs offered and available, the predicted costs and likely clinical outcomes, and/or other information. In some embodiments, recommendation component 34 is configured to recommend an individual moment (e.g., day) that corresponds to the fewest and/or most manageable care needs, the lowest projected costs and/or the best clinical outcome, and/or other information for subject 12. By way of a non-limiting example, suppose all possible costs and medical outcomes are considered and scaled in a range from 0 to 1. An algorithm is used to balance these two factors (costs versus medical outcomes). In some embodiments, a factor alpha is chosen based on the insurance package of the beneficiary (e.g., subject 12) to optimize the weight sum of cost and outcome: alpha*outcome+(1−alpha)*cost. For premium insurance plans, the alpha will approach 1, while in less expensive plans, the cost optimization will receive more weight in the evaluation.

Recommendation component 34 is configured to communicate the recommendation to one or more administrators, caregivers, subject 12, and/or other users. Recommendation component 34 is configured to communicate via user interface 42, via email, via text messages, via a website, via a phone call, and/or with other forms of communication. For example, in some embodiments, recommendation component 34 causes user interface 42 to display information (e.g., an alert indication) that communicates the recommendation to an administrator, a caregiver, subject 12, and/or other people. In some embodiments, recommendation component 34 is configured to send an email or a text with such information to the administrator, the caregiver, subject 12, and/or other people. By way of a non-limiting example, an administrator may then determine when to discharge subject 12 (e.g., from the hospital) and/or take other actions based on the recommended moment.

Electronic storage 40 comprises electronic storage media that electronically stores information. The electronic storage media of electronic storage 40 may comprise one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 40 may be (in whole or in part) a separate component within system 10, or electronic storage 40 may be provided (in whole or in part) integrally with one or more other components of system 10 (e.g., user interface 44, processor 20, etc.). In some embodiments, electronic storage may be located in a server together with processor 20, in a server that is part of external resources 44, in a computing device associated with one or more administrators, one or more caregivers, subject 12, and/or other users, and/or in other locations. Electronic storage 40 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 40 may store software algorithms, information determined by processor 20, information received via user interface 42 and/or external computing systems, information received from external resources 44, information received from sensors 14, and/or other information that enables system 10 to function as described herein.

User interface 42 is configured to receive information from and/or provide information to one or more users (e.g., subject 12, caregivers, administrators, etc.) of system 10. User interface 42 is configured to provide an interface between system 10 and administrators, caregivers, subject 12, and/or other users through which administrators, caregivers, subject 12, and/or other users may provide information to and receive information from system 10. This enables data, cues, results, and/or instructions and any other communicable items, collectively referred to as “information,” to be communicated between a user (e.g., an administrator, a caregiver, subject 12, and/or other users) and processor 20, and/or other components of system 10. For example, a recommended discharge date may be communicated from system 10 to an administrator, caregiver, subject 12, and/or other users via user interface 42. In some embodiments, user interface 42 is configured to display the possible discharge moments in an ordered list and/or in other ways. User interface 42 may be configured to display the ordered list such that a best discharge moment (e.g., the recommended discharge moment described above) is displayed first in the list, for example.

Examples of interface devices suitable for inclusion in user interface 42 comprise a graphical user interface, a display, a touchscreen, a keypad, buttons, switches, a keyboard, knobs, levers, speakers, a microphone, an indicator light, an audible alarm, a printer, a haptic feedback device, and/or other interface devices. In some embodiments, user interface 42 comprises a plurality of separate interfaces. For example, user interface 42 may comprise a plurality of different interfaces associated with a plurality of computing devices associated with different administrators and/or caregivers; an interface that is part of a computing device associated with subject 12; an interface associated with processor 20, electronic storage 40, external resources 44, sensors 14, and/or other components of system 10; an interface included in a server that also includes processor 20 and/or electronic storage 40; and/or other interfaces. User interface 42 is configured such that a plurality of administrators, caregivers, subject 12, and/or other users may provide information to and receive information from system 10 via the individual ones of the plurality of user interfaces. In some embodiments, user interface 42 comprises at least one interface that is provided integrally with processor 20 and/or other components of system 10.

It is to be understood that other communication techniques, either hard-wired or wireless, are also contemplated by the present disclosure as user interface 42. For example, the present disclosure contemplates that user interface 42 may be integrated with a removable storage interface provided by electronic storage 40. In this example, information may be loaded into system 10 from removable storage (e.g., a smart card, a flash drive, a removable disk, etc.) that enables the user(s) to customize the implementation of system 10. Other exemplary input devices and techniques adapted for use with system 10 as user interface 42 comprise, but are not limited to, an RS-232 port, RF link, an IR link, modem (telephone, cable or other). In short, any technique for communicating information with system 10 is contemplated by the present disclosure as user interface 16.

External resources 44 includes sources of information (e.g., databases, websites, etc.), external entities participating with system 10 (e.g., a medical records system of a health care provider), medical equipment configured to communicate with external systems, one or more servers outside of system 10, a network (e.g., the internet), electronic storage, equipment related to Wi-Fi technology, equipment related to Bluetooth® technology, data entry devices, sensors, scanners, computing devices associated with individual users, and/or other resources. For example, in some embodiments, external resources 44 include the one or more external clinical databases, the one or more external billing and authorization databases, the services database, the historic database of patient information, a database that includes information describing the outpatient conditions where subject 12 is to be transferred and/or the preferences of subject 12, and/or other sources of information. In some implementations, some or all of the functionality attributed herein to external resources 44 may be provided by resources included in system 10. External resources 44 may be configured to communicate with sensors 14, processors 20, electronic storage 40, user interface 42, and/or other components of system 10 via wired and/or wireless connections, via a network (e.g., a local area network and/or the internet), via cellular technology, via Wi-Fi technology, and/or via other resources.

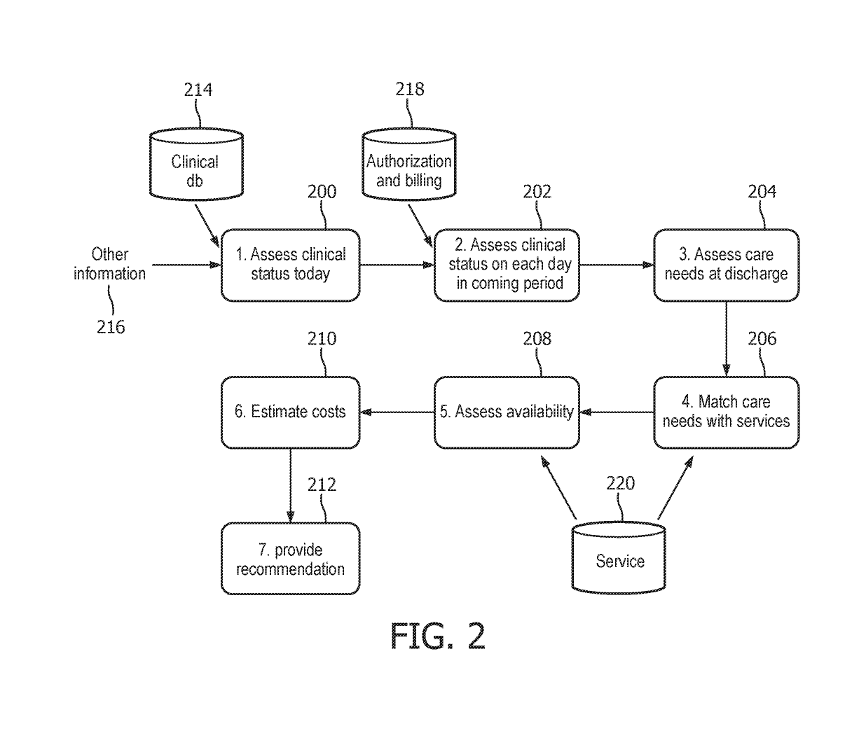

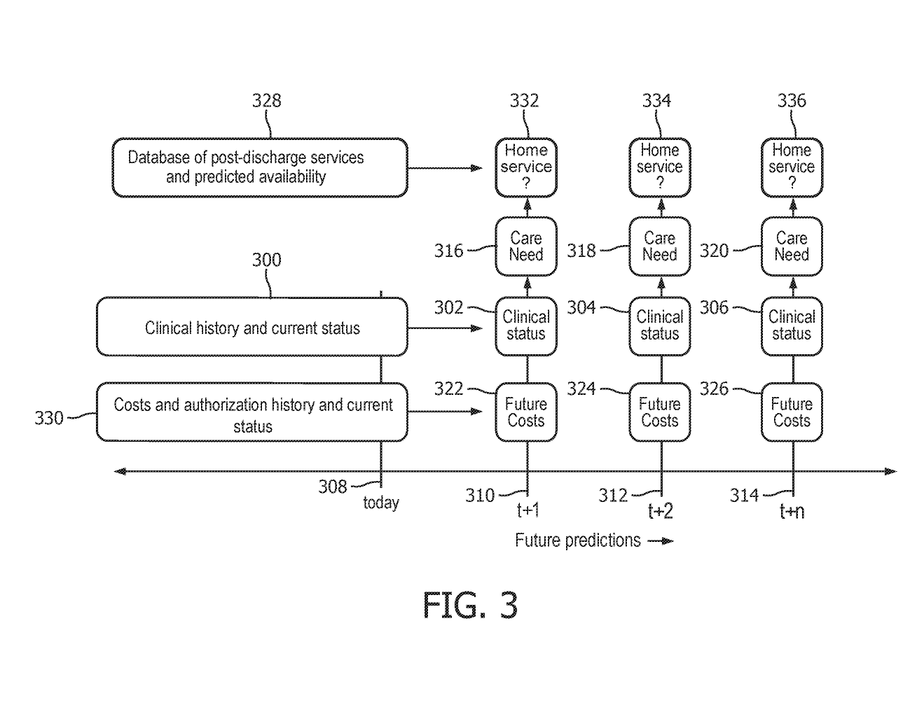

FIG. 2 and FIG. 3 summarize operations performed by system 10. Discharge days are used in both FIG. 2 and FIG. 3 as examples of possible discharge moments. The operations illustrated in FIGS. 2 and 3 are examples and should not be considered limiting. In some embodiments, system 10 may perform more or less operations than the ones shown in FIG. 2 and FIG. 3 and/or the discharge moments may be moments other than discharge days.

FIG. 2 illustrates seven operations 200-212 performed by system 10. At operation 200, system 10 assesses and/or determines (as described above) the clinical status of a subject (e.g. subject 12) for the current day (e.g., today). As shown in FIG. 2, the clinical status is quantified based on information in a clinical database 214 and other information 216 (e.g., information related to the clinical progression of subject 12 described above such as vital signs, information related to why the subject requires hospitalization and professional care, etc.). At operation 202 system 10, using the clinical status and billing and authorization history from a billing and authorization history database 218, predicts the clinical status of the subject for the next “n” days in the future. At an operation 204, system 10 determines care needs of the subject for individual days of the “n” days for the predicted clinical status on that day. At an operation 206, system 10 obtains information indicating medical services and programs offered to the subject on the one or more individual “n” days in the future and whether the offered medical services and programs meet the subject's predicted needs on the one or more individual days. The offered medical services and programs information may be obtained from a services database 220, for example, and/or from other sources. At an operation 208, system 10, for days where services and programs that meet the needs of the subject are offered, determines the availability of the services and programs. As shown in FIG. 2, the availability information may be obtained from services database 220 and/or other sources. At an operation 210, system 10 predicts costs and likely clinical outcomes for the subject for hospital discharge on the one or more individual days in the future based on the predicted clinical status and when the medical services and programs that meet the predicted needs of the subject and are offered and available. At an operation 212, system 10 recommends one of the one or more individual “n” days in the future as a discharge date based on the predicted costs and clinical outcomes

FIG. 3 illustrates determining costs and projected clinical outcomes for subject discharge at discharge moments comprising various discharge days. FIG. 3 illustrates determining costs and projected clinical outcomes for subject discharge on a current day and three different days in the future. As shown in FIG. 3, the clinical history and the current clinical status 300 of the subject are used to predict future statuses 302, 304, 306 on potential discharge days 308, 310, 312, and 314. As described above, these determined statuses are used to predict corresponding care needs 316, 318, 320 for the potential discharge days 310, 312, and 314. Using information in a services database 328 (e.g., and/or services database 220 shown in FIG. 2), the availability of these services 332, 334, 336 is assessed by system 10 for the potential discharge days. System 10 predicts future costs for caring for the subject 322, 324, 326 for the possible discharge days 310, 312, 314 based on past costs, past authorization history, current clinical status, and/or other information 330. This leads to a recommended discharge day based on costs and anticipated outcomes, as well as when the right level of care is available to the subject.

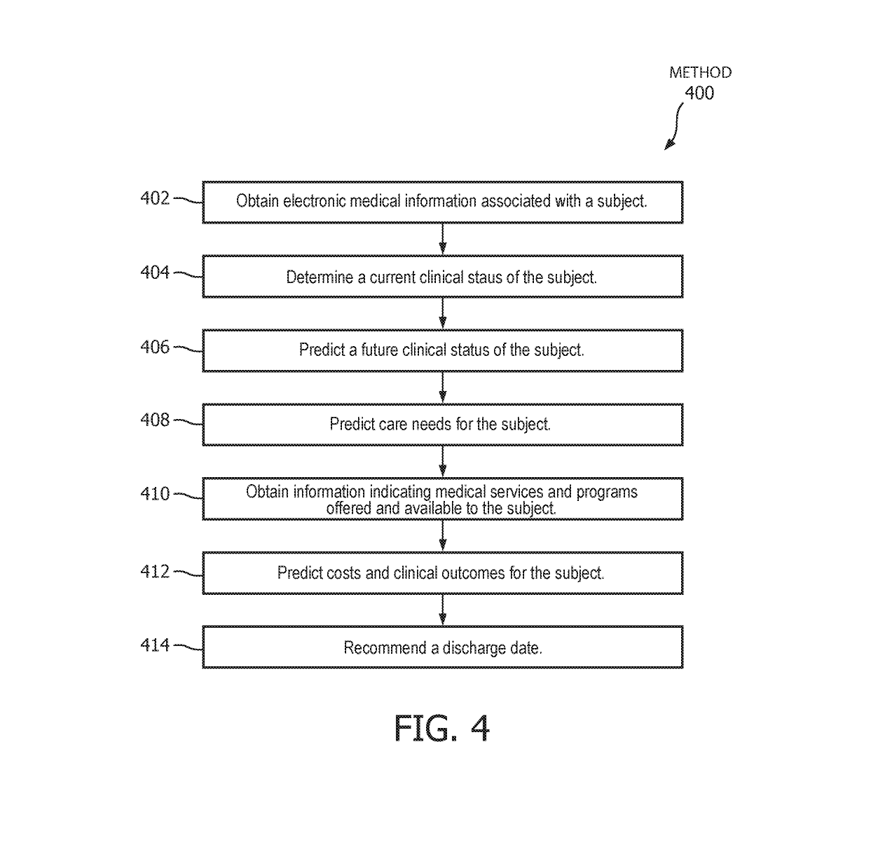

FIG. 4 illustrates a method 400 for recommending a discharge moment for a subject with a recommendation system. The system comprises one or more hardware processors and/or other components. The one or more hardware processors are configured by machine readable instructions to execute computer program components. The computer program components comprise a medical information component, a current clinical status component, a predicted clinical status component, a predicted care needs component, a medical services component, a costs and outcomes component, a recommendation component, and/or other components. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, electronic medical information associated with the subject is obtained. The electronic medical information indicates a clinical progression of the subject, a medical billing history associated with the subject, a medical procedure authorization history associated with the subject, and/or other information. The electronic medical information is obtained from one or more external clinical databases that include the information indicating the clinical progression of the subject, the information indicating the clinical progression of the subject comprising one or more of vital signs levels of the subject, test results from tests performed on the subject, diagnoses associated with the subject, information describing treatments performed on the subject, information describing exercises performed by the subject, medications given to the subject, previous hospital admission and discharge dates for previous hospital visits by the subject, dates of medical office visits, notes recorded by a care giver, and/or other information. In some embodiments, the electronic medical information is obtained from one or more external billing and authorization databases that include the medical billing and authorization history, the medical billing and authorization history including one or more of processed billing codes, insurance payment information, diagnostic codes, or past and pending authorization requests. In some embodiments, the recommendation system further comprises one or more physiological sensors configured to generate output signals conveying information related to the vital signs levels of the subject. In some embodiments, the electronic medical information in the one or more external clinical databases is collected by one or more of the subject, by a caregiver in outpatient or inpatient settings, collected during previous visits to the hospital, or collected during a current hospital visit via the one or more physiological sensors. In some embodiments, operation 402 is performed by a processor component the same as or similar to medical information component 22 (shown in FIG. 1 and described herein).

At an operation 404, a current clinical status of the subject is determined. The current clinical status is determined based on the clinical progression and/or other information. Determining the current clinical status of the subject based on the clinical progression includes individually quantifying a disease profile, a disease severity, a clinical stability, a daily living ability, and therapy administered to the subject on a scale of 0, which corresponds to a healthy subject, to 1, which corresponds to a bedridden subject requiring professional care, based on the information in the one or more external clinical databases. In some embodiments, operation 404 is performed by a processor component the same as or similar to current clinical status component 24 (shown in FIG. 1 and described herein).

At an operation 406, a future clinical status of the subject is predicted. The future clinical status for the subject is predicted for one or more individual moments in the future based on the current clinical status, the clinical progression, the medical billing history, the medical procedure authorization history, and/or other information. In some embodiments, operation 406 is performed by a processor component the same as or similar to predicted clinical status component 26 (shown in FIG. 1 and described herein).

At an operation 408, care needs for the subject are predicted. The care needs for the subject at the one or more individual moments in the future are predicted based on the predicted clinical status and/or other information. In some embodiments, operation 408 is performed by a processor component the same as or similar to predicted care needs component 28 (shown in FIG. 1 and described herein).

At an operation 410, information indicating medical services offered and available to the subject is obtained. Information indicating medical services and programs offered and available to the subject at the one or more individual moments in the future is obtained along with information that indicates whether the offered available medical services and programs meet the subject's predicted needs at the one or more individual moments. In some embodiments, operation 410 is performed by a processor component the same as or similar to medical services component 30 (shown in FIG. 1 and described herein).

At an operation 412, costs and clinical outcomes for the subject are predicted. Costs and likely clinical outcomes for the subject for discharge are predicted for the one or more individual moments in the future. Costs and likely clinical outcomes are predicted based on the predicted clinical status and when the medical services and programs that meet the predicted needs of the subject and are offered and available. In some embodiments, predicting costs and likely clinical outcomes for the subject for discharge at the one or more individual moments in the future is further based on information stored in a historic database of patient information which includes a description of the patients' associated medical conditions and the patients' corresponding billing history. In some embodiments, the method further comprises comparing the predicted clinical status of the subject, and the offered and available medical services and programs that meet the predicted needs of the subject, to the information in the historic database of patient information and predicting the costs and likely clinical outcomes for the subject for discharge at the one or more individual moments in the future based on the comparison. In some embodiments, operation 412 is performed by a processor component the same as or similar to costs and outcomes component 32 (shown in FIG. 1 and described herein).

At an operation 414, a discharge moment is recommended. One of the one or more individual moments in the future is recommended as a discharge moment based on the predicted costs and clinical outcomes and/or other information. In some embodiments, operation 414 is performed by a processor component the same as or similar to recommendation component 34 (shown in FIG. 1 and described herein).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A system configured to recommend a discharge moment for a subject, the system comprising:
one or more hardware processors configured by machine-readable instructions to:
obtain electronic medical information associated with the subject, the electronic medical information indicating a clinical progression of the subject, a medical billing history associated with the subject, and a medical procedure authorization history associated with the subject;
determine a current clinical status of the subject based on the clinical progression;
predict a clinical status for the subject at one or more individual moments in the future based on the current clinical status, the clinical progression, the medical billing history, and the medical procedure authorization history;
predict care needs for the subject at the one or more individual moments in the future based on the predicted clinical status; and
recommend one of the one or more individual moments in the future as the discharge moment based on the predicted care needs.

2. The system of claim 1, wherein the one or more hardware processors are configured such that the electronic medical information is obtained from one or more external clinical databases that include the information indicating the clinical progression of the subject, the information indicating the clinical progression of the subject comprising one or more of vital signs levels of the subject, test results from tests performed on the subject, diagnoses associated with the subject, information describing treatments performed on the subject, information describing exercises performed by the subject, medications given to the subject, previous hospital admission and discharge dates for previous hospital visits by the subject, dates of medical office visits, medical symptoms experienced by the subject, or notes recorded by a care giver.

3. The system of claim 2, wherein the one or more hardware processors are configured such that determining the current clinical status of the subject based on the clinical progression includes individually quantifying a disease profile, a disease severity, a clinical stability, a daily living ability, and therapy administered to the subject on a scale of 0, which corresponds to a healthy subject, to 1, which corresponds to a bedridden subject requiring professional care, based on the information in the one or more external clinical databases.

4. The system of claim 2, further comprising one or more physiological sensors configured to generate output signals conveying information related to the vital signs levels of the subject, and a user interface configured to obtain the medical symptoms associated with the subject via a questionnaire presented to the subject on the user interface,
and wherein the one or more hardware processors are configured such that the electronic medical information in the one or more external clinical databases is collected by one or more of the subject, by a caregiver in outpatient or inpatient settings, collected during previous visits to the hospital, or collected during a current hospital visit via the one or more physiological sensors and the user interface.

5. The system of claim 1, wherein the one or more hardware processors are configured such that the electronic medical information is obtained from one or more external billing and authorization databases that include the medical billing and authorization history, the medical billing and authorization history including one or more of processed billing codes, insurance payment information, diagnostic codes, or past and pending authorization requests.

6. The system of claim 1, wherein the one or more hardware processors are further configured to:
obtain information indicating medical services and programs offered and available to the subject at the one or more individual moments in the future and whether the offered available medical services and programs meet the subject's predicted care needs at the one or more individual moments;
predict costs and likely clinical outcomes for the subject for discharge at the one or more individual moments in the future based on the predicted clinical status and when the medical services and programs that meet the predicted care needs of the subject and are offered and available; and
recommend one of the one or more individual moments in the future as the discharge moment based on the predicted costs and likely clinical outcomes.

7. The system of claim 6, wherein the one or more hardware processors are configured such that predicting costs and likely clinical outcomes for the subject for discharge at the one or more individual moments in the future is further based on information stored in a historic database of patient information which includes a description of the patients' associated medical conditions and the patients' corresponding billing history,
and wherein the one or more hardware processors are configured to compare the predicted clinical status of the subject, and the offered and available medical services and programs that meet the predicted care needs of the subject, to the information in the historic database of patient information and predict the costs and likely clinical outcomes for the subject for discharge at the one or more individual moments in the future based on the comparison.

8. A method for recommending a discharge moment for a subject with a recommendation system, the system comprising one or more hardware processors, the method comprising:
obtaining, with the one or more hardware processors, electronic medical information associated with the subject, the electronic medical information indicating a clinical progression of the subject, a medical billing history associated with the subject, and a medical procedure authorization history associated with the subject;
determining, with the one or more hardware processors, a current clinical status of the subject based on the clinical progression;
predicting, with the one or more hardware processors, a clinical status for the subject at one or more individual moments in the future based on the current clinical status, the clinical progression, the medical billing history, and the medical procedure authorization history;
predicting, with the one or more hardware processors, care needs for the subject at the one or more individual moments in the future based on the predicted clinical status; and
recommending, with the one or more hardware processors, one of the one or more individual moments in the future as the discharge moment based on the predicted care needs.

9. The method of claim 8, wherein the electronic medical information is obtained from one or more external clinical databases that include the information indicating the clinical progression of the subject, the information indicating the clinical progression of the subject comprising one or more of vital signs levels of the subject, test results from tests performed on the subject, diagnoses associated with the subject, information describing treatments performed on the subject, information describing exercises performed by the subject, medications given to the subject, previous hospital admission and discharge dates for previous hospital visits by the subject, dates of medical office visits, medical symptoms experienced by the subject, or notes recorded by a care giver.

10. The method of claim 9, wherein determining the current clinical status of the subject based on the clinical progression includes individually quantifying a disease profile, a disease severity, a clinical stability, a daily living ability, and therapy administered to the subject on a scale of 0, which corresponds to a healthy subject, to 1, which corresponds to a bedridden subject requiring professional care, based on the information in the one or more external clinical databases.

11. The method of claim 9, wherein the recommendation system further comprises one or more physiological sensors configured to generate output signals conveying information related to the vital signs levels of the subject, and a user interface configured to obtain the medical symptoms associated with the subject via a questionnaire presented to the subject on the user interface,
and wherein the electronic medical information in the one or more external clinical databases is collected by one or more of the subject, by a caregiver in outpatient or inpatient settings, collected during previous visits to the hospital, or collected during a current hospital visit via the one or more physiological sensors and the user interface.

12. The method of claim 8, wherein the electronic medical information is obtained from one or more external billing and authorization databases that include the medical billing and authorization history, the medical billing and authorization history including one or more of processed billing codes, insurance payment information, diagnostic codes, or past and pending authorization requests.

13. The method of claim 8, further comprising:
obtaining, with the one or more hardware processors, information indicating medical services and programs offered and available to the subject at the one or more individual moments in the future and whether the offered available medical services and programs meet the subject's predicted care needs at the one or more individual moments;
predicting, with the one or more hardware processors, costs and likely clinical outcomes for the subject for discharge at the one or more individual moments in the future based on the predicted clinical status and when the medical services and programs that meet the predicted care needs of the subject and are offered and available; and
recommending one of the one or more individual moments in the future as the discharge moment based on the predicted costs and likely clinical outcomes.

14. The method of claim 13, wherein predicting costs and likely clinical outcomes for the subject for discharge at the one or more individual moments in the future is further based on information stored in a historic database of patient information which includes a description of the patients' associated medical conditions and the patients' corresponding billing history, and
wherein the method further comprises comparing the predicted clinical status of the subject, and the offered and available medical services and programs that meet the predicted care needs of the subject, to the information in the historic database of patient information and predicting the costs and likely clinical outcomes for the subject for discharge at the one or more individual moments in the future based on the comparison.

15. A system configured to recommend a discharge moment for a subject, the system comprising:
means for obtaining electronic medical information associated with the subject, the electronic medical information indicating a clinical progression of the subject, a medical billing history associated with the subject, and a medical procedure authorization history associated with the subject;
means for determining a current clinical status of the subject based on the clinical progression;
means for predicting a clinical status for the subject at one or more individual moments in the future based on the current clinical status, the clinical progression, the medical billing history, and the medical procedure authorization history;
means for predicting care needs for the subject at the one or more individual moments in the future based on the predicted clinical status; and
means for recommending one of the one or more individual moments in the future as the discharge moment based on the predicted care needs.

16. The system of claim 15, wherein the electronic medical information is obtained from one or more external clinical databases that include the information indicating the clinical progression of the subject, the information indicating the clinical progression of the subject comprising one or more of vital signs levels of the subject, test results from tests performed on the subject, diagnoses associated with the subject, information describing treatments performed on the subject, information describing exercises performed by the subject, medications given to the subject, previous hospital admission and discharge dates for previous hospital visits by the subject, dates of medical office visits, medical symptoms experienced by the subject, or notes recorded by a care giver.

17. The system of claim 16, wherein determining the current clinical status of the subject based on the clinical progression includes individually quantifying a disease profile, a disease severity, a clinical stability, a daily living ability, and therapy administered to the subject on a scale of 0, which corresponds to a healthy subject, to 1, which corresponds to a bedridden subject requiring professional care, based on the information in the one or more external clinical databases.

18. The system of claim 16, further comprising means for generating output signals conveying information related to the vital signs levels of the subject, and means for obtaining the medical symptoms associated with the subject via a questionnaire presented to the subject on the means for obtaining the medical symptoms,
and wherein the electronic medical information in the one or more external clinical databases is collected by one or more of the subject, by a caregiver in outpatient or inpatient settings, collected during previous visits to the hospital, or collected during a current hospital visit via the means for generating output signals and the means for obtaining the medical symptoms.

19. The system of claim 15, wherein the electronic medical information is obtained from one or more external billing and authorization databases that include the medical billing and authorization history, the medical billing and authorization history including one or more of processed billing codes, insurance payment information, diagnostic codes, or past and pending authorization requests.

20. The system of claim 15, further comprising:
means for obtaining information indicating medical services and programs offered and available to the subject at the one or more individual moments in the future and whether the offered available medical services and programs meet the subject's predicted care needs at the one or more individual moments;
means for predicting costs and likely clinical outcomes for the subject for discharge at the one or more individual moments in the future based on the predicted clinical status and when the medical services and programs that meet the predicted care needs of the subject and are offered and available; and
means for recommending one of the one or more individual moments in the future as the discharge moment based on the predicted costs and clinical outcomes.

21. The system of claim 20, wherein predicting costs and likely clinical outcomes for the subject for discharge at the one or more individual moments in the future is further based on information stored in a historic database of patient information which includes a description of the patients' associated medical conditions and the patients' corresponding billing history,
and wherein the system further comprises means for comparing the predicted clinical status of the subject, and the offered and available medical services and programs that meet the predicted care needs of the subject, to the information in the historic database of patient information and predict the costs and likely clinical outcomes for the subject for discharge at the one or more individual moments in the future based on the comparison.
